(19) United States
(12) Patent Application Publication
(10) Pub. No.: US 2015/0236966 A1
(43) Pub. Date: Aug. 20, 2015

(54) CONTROL OF CONGESTION WINDOW SIZE OF AN INFORMATION TRANSMISSION CONNECTION

(71) Applicants: Andrea Francini, Mooresville, NC (US); Sameer Sharma, Holmdel, NJ (US); Viorel Craciun, Ottawa (CA); Shahid Akhtar, Richardson, TX (US); Peter Beecroft, Cambridge (GB)

(72) Inventors: Andrea Francini, Mooresville, NC (US); Sameer Sharma, Holmdel, NJ (US); Viorel Craciun, Ottawa (CA); Shahid Akhtar, Richardson, TX (US); Peter Beecroft, Cambridge (GB)

(73) Assignees: ALCATEL-LUCENT USA INC., Murray Hill, NJ (US); ALCATEL-LUCENT CANADA INC., Ottawa (CA); ALCATEL LUCENT, Boulogne-Billancourt (FR)

(21) Appl. No.: 14/562,050

(22) Filed: Dec. 5, 2014

Related U.S. Application Data
(60) Provisional application No. 61/940,945, filed on Feb. 18, 2014.

(51) Int. Cl. H04L 12/807; H04L 12/26; H04L 29/06

(52) U.S. Cl. CPC H04L 47/27; H04L 69/16; H04L 43/0864

(57) ABSTRACT

A capability for controlling a size of a congestion window of an information transmission connection (ITC) is provided. The size of the congestion window of the ITC may be controlled based on a threshold, which may be based on an ideal bandwidth-delay product (IBDP) value. The IBDP value may be based on a product of an information transmission rate measure and a time measure. The information transmission rate measure may be based on a target information transmission rate for the ITC. The time measure may be based on a round-trip time measured between a sender of the ITC and a receiver of the ITC. The threshold may be a cap threshold where the size of the congestion window is prevented from exceeding the cap threshold. The threshold may be a reset threshold which may be used to control a reduction of the size of the congestion window.

### CROSS-REFERENCE TO RELATED APPLICATIONS

This application claims the benefit of U.S. Provisional Patent Application Ser. No. 61/940,945, filed on Feb. 18, 2014, entitled “Control Of Transmission Control Protocol Congestion Window For A Video Source,” which is hereby incorporated herein by reference.

### TECHNICAL FIELD

The disclosure relates generally to communication networks and, more specifically but not exclusively, to controlling congestion in communication networks.

### BACKGROUND

Transmission Control Protocol (TCP) is a common transport layer protocol used for controlling transmission of packets via a communication network. TCP is a connection-oriented protocol that supports transmission of packets between a TCP sender and a TCP receiver via an associated TCP connection established between the TCP sender and the TCP receiver. TCP supports use of a congestion window which controls the rate at which the TCP sender sends data packets to the TCP receiver. While typical use of the TCP congestion window may provide adequate congestion control in many cases, there may be situations in which typical use of the TCP congestion window does not provide adequate congestion control or may result in undesirable effects.

### SUMMARY OF EMBODIMENTS

Various deficiencies in the prior art may be addressed by embodiments for controlling congestion in a communication network.

In at least some embodiments, an apparatus includes a processor and a memory communicatively connected to the processor, wherein the processor is configured to control a size of a congestion window of an information transmission connection based on a threshold, wherein the threshold is based on an ideal bandwidth-delay product (IBDP) value, wherein the IBDP value is based on a product of an information transmission rate measure and a time measure.

In at least some embodiments, a computer-readable storage medium stores instructions which, when executed by a computer, cause the computer to perform a method that includes controlling a size of a congestion window of an information transmission connection based on a threshold, wherein the threshold is based on an ideal bandwidth-delay product (IBDP) value, wherein the IBDP value is based on a product of an information transmission rate measure and a time measure.

In at least some embodiments, a method includes controlling, using a processor and a memory communicatively connected to the processor, a size of a congestion window of an information transmission connection based on a threshold, wherein the threshold is based on an ideal bandwidth-delay product (IBDP) value, wherein the IBDP value is based on a product of an information transmission rate measure and a time measure.

In at least some embodiments, an apparatus includes a processor and a memory communicatively connected to the processor, wherein the processor is configured to control a size of a congestion window of an information transmission connection based on a cap threshold and based on a reset threshold. The processor is configured to prevent the size of the congestion window from exceeding the cap threshold. The processor is configured to reduce the size of the congestion window, prior to transmitting a new information block from a sender of the information transmission connection toward a receiver of the information transmission connection, based on a determination that the size of the congestion window exceeds the reset threshold and based on a determination that the sender of the information transmission connection has received confirmation that one or more information blocks already transmitted by the sender of the information transmission connection toward the receiver of the information transmission connection have been received by the receiver of the information transmission connection.

In at least some embodiments, a computer-readable storage medium stores instructions which, when executed by a computer, cause the computer to perform a method that includes controlling a size of a congestion window of an information transmission connection based on a cap threshold and based on a reset threshold. The method includes preventing the size of the congestion window from exceeding the cap threshold. The method includes reducing the size of the congestion window, prior to transmitting a new information block from a sender of the information transmission connection toward a receiver of the information transmission connection, based on a determination that the size of the congestion window exceeds the reset threshold and based on a determination that the sender of the information transmission connection has received confirmation that one or more information blocks already transmitted by the sender of the information transmission connection toward the receiver of the information transmission connection have been received by the receiver of the information transmission connection.

In at least some embodiments, a method includes controlling, using a processor and a memory communicatively connected to the processor, a size of a congestion window of an information transmission connection based on a cap threshold and based on a reset threshold. The method includes preventing the size of the congestion window from exceeding the cap threshold. The method includes reducing the size of the congestion window, prior to transmitting a new information block from a sender of the information transmission connection toward a receiver of the information transmission connection, based on a determination that the size of the congestion window exceeds the reset threshold and based on a determination that the sender of the information transmission connection has received confirmation that one or more information blocks already transmitted by the sender of the information transmission connection toward the receiver of the information transmission connection have been received by the receiver of the information transmission connection.

### BRIEF DESCRIPTION OF THE DRAWINGS

The teachings herein can be readily understood by considering the following detailed description in conjunction with the accompanying drawings, in which:

FIG. 1 depicts an exemplary system supporting a TCP connection between a TCP sender and a TCP receiver;

FIG. 2 depicts an exemplary embodiment of a method for calculating a minimum round-trip time (minRTT);

FIGS. 3A and 3B depict an exemplary embodiment of a method for controlling a congestion window size for a congestion window of a TCP connection;

FIGS. 4A, 4B, 4C, and 4D depict an exemplary embodiment of a method for controlling a congestion window size for a congestion window of a TCP connection; and

FIG. 5 depicts a high-level block diagram of a computer suitable for use in performing functions described herein.

To facilitate understanding, identical reference numerals have been used, where possible, to designate identical elements common to the figures.

### DETAILED DESCRIPTION OF EMBODIMENTS

The present disclosure provides a capability for controlling a size of a congestion window of an information transmission connection. The information transmission connection may be a network connection (e.g., a Transmission Control Protocol (TCP) connection or other suitable type of network connection) or other suitable type of information transmission connection. The information transmission connection may be used to transmit various types of information, such as content (e.g., audio, video, multimedia, or the like, as well as various combinations thereof) or any other suitable types of information. The size of the congestion window of the information transmission connection may be controlled based on one or more of a target encoding rate of information to be transmitted via the information transmission connection (e.g., the encoding rate of the highest quality level of the information to be transported via the information transmission connection), round-trip time (RTT) information associated with the information transmission connection (e.g., an RTT, a minimum RTT, or the like), or buffer space that is available to packets of the information transmission connection along links of which a path of the information transmission connection is composed. The size of the congestion window of the information transmission connection may be controlled in a manner tending to maintain the highest quality of information to be transmitted via the information transmission connection.

The present disclosure provides embodiments of methods and functions for reaching and maintaining the highest quality of adaptive bit-rate data streamed over a Transmission Control Protocol (TCP) compliant network connection (which also may be referred to as a TCP connection or, more generally, as a network connection) based on adjustments of a congestion window (cwnd) of the TCP connection that are based on at least one or more of (i) the encoding rate of the highest quality level of the streamed data, (ii) the round-trip time (RTT) of the TCP connection carrying the streamed data, and (iii) the buffer space available to packets of the TCP connection in front of the links that make up its network path. The methods and functions of the present disclosure apply to the TCP sender (i.e., the data source side of the TCP connection) and coexist with its ordinary mode of operation, as it is defined in published standards or specified in proprietary implementations. A description of the ordinary mode of operation of a TCP sender follows.

Along the network path of a TCP connection, typically composed of multiple network links, there is always at least one network link where the data transmission rate (or simply the data rate) experienced by packets of the TCP connection is the lowest within the entire set of links of the network path. Such a network link is called the bottleneck link of the TCP connection. The packet buffer memory that may temporarily store the packets of the TCP connection before they are transmitted over the bottleneck link is referred to as the bottleneck buffer. Congestion occurs at a bottleneck link when packets arrive to the bottleneck buffer faster than they can depart. When congestion is persistent, packets accumulate in the bottleneck buffer and packet losses may occur. To minimize the occurrence of packet losses, which delay the delivery of data to the TCP receiver and therefore reduce the effective data rate of the TCP connection, the TCP sender reacts to packet losses or to increases in packet delivery delay by adjusting the size of its congestion window.

The TCP congestion window controls the rate at which the TCP sender dispatches data packets to the TCP receiver. It defines the maximum allowed flight size. The flight size is the difference between the highest sequence number of a packet transmitted by the TCP sender and the highest ACK number received by the TCP sender. The ACK number is carried by acknowledgment packets that the TCP receiver transmits to the TCP sender on the reverse network path of the TCP connection after receiving data packets from the TCP sender on the forward network path of the TCP connection. The ACK number carried by an acknowledgment packet is typically the next sequence number that the TCP receiver expects to receive with a data packet on the forward path of the TCP connection. When the flight size matches the congestion window size, the TCP sender stops transmitting data packets until it receives the next acknowledgment packet with a higher ACK number than the current highest ACK number. The TCP sender stops transmitting new packets as soon as the flight size again matches the congestion window size.

The TCP sender adjusts the size of the TCP congestion window according to the sequence of events that it infers as having occurred along the network path of the TCP connection based on the sequence of ACK numbers that it receives on the reverse path of the TCP connection and also based on the time at which it receives those ACK numbers. The TCP sender typically increases the size of the congestion window, at a pace that changes depending on the specific TCP sender implementation in use, until it recognizes that a packet was lost somewhere along the network path of the TCP connection, or that data packets or acknowledgment packets have started accumulating in front of a network link. The TCP sender may reduce the size of its congestion window when it detects any one of the following conditions: (1) arrival of multiple acknowledgment packets carrying the same ACK number; (2) expiration of a retransmission timeout; or (3) increase of the TCP connection round-trip time (RTT). The RTT measures the time between the transmission of a data packet and the receipt of the corresponding acknowledgment packet. The growth of the congestion window size also stops when such size matches the size of the receiver window (rwnd). The TCP receiver advertises the value of rwnd to the TCP sender using the same acknowledgment packets that carry the ACK numbers. The receiver window size stored by the TCP receiver in the acknowledgment packet for notification to the TCP sender is called the advertised receiver window (arwnd).

As an example, consider an adaptive bit-rate (ABR) video source (e.g., located at a video application server) offering video content encoded at multiple encoding rates (although it will be appreciated that the ABR source may offer content other than video). Each encoding rate corresponds to a video quality level. A higher encoding rate implies a better video quality, which is obtained through a larger number of bytes of encoded video content per time unit. The video asset is packaged into segments of fixed duration (e.g., 2 seconds, 4 seconds, or 10 seconds) that the video application client will request from the video application server as ordinary web objects using Hypertext Transfer Protocol (HTTP) messages. The video segments are commonly referred to as video chunks. When the video application client requests a video asset, the video source at the video application server responds with a manifest file that lists the encoding rates available for the video asset and where the chunks encoded at different video quality levels can be found. As the transmission of the video progresses, the video application client requests subsequent chunks having video quality levels that are consistent with the network path data rate measured for previously received chunks and other metrics that the video application client maintains. One of those additional metrics is the amount of video content already buffered by the client that is awaiting reproduction by a video player used by the client to play the received video.

Typically, the ABR video application client requests a new video chunk only after having received the last packet of a previous chunk. For the TCP sender at the video application server, this implies that there is always a period of inactivity located between the transmission of the last packet of a chunk and the transmission of the first packet of a new chunk. When the transmission of the new chunk starts, the TCP sender is allowed to transmit a number of back-to-back packets up to fulfillment of the current size of the congestion window. This sequence of back-to-back packets may depart from the TCP sender at a much higher rate than the data rate available to the TCP connection at the bottleneck link. As a consequence, a majority of the packets in this initial burst may accumulate in the bottleneck buffer. If the size of the congestion window is larger than the size of the buffer, one or more packets from the initial burst may be dropped. In standards-compliant TCP sender instances the loss of a packet during the initial burst requires the retransmission of the lost packet and induces a downward correction of the congestion window size. Both the packet retransmission and the window size drop contribute to a reduction of the TCP connection data rate and, therefore, of the data rate (or throughput) sample that the video application client measures for the chunk after receiving its last packet. The lower throughput sample may then translate into the selection of a lower video quality level by the video application client.

In at least some embodiments, methods are provided for controlling the size of a congestion window of a TCP sender in a manner for satisfying the throughput requirement discussed above. The methods for controlling the size of the congestion window are configured to minimize the probability of packet losses occurring during the initial burst of a chunk transmission, so that the size of the congestion window during the entire chunk transmission is relatively higher and, therefore, conducive to a relatively higher throughput sample for the chunk being transmitted. A first embodiment of the present disclosure, called TCP window reset (TWR), provides a method of operating a TCP sender which satisfies the throughput requirement discussed above. The method of the first embodiment of the present disclosure drops the size of the congestion window to a carefully determined size immediately before the TCP sender starts transmitting the packets of a new chunk. It will be appreciated that application of the TWR method is not restricted to TCP senders associated with adaptive bit-rate video sources, but may be extended to any TCP sender that alternates the transmission of data packets with periods of inactivity.

When multiple ABR video streams share a common bottleneck link in their respective network paths, the data rate share obtained by each stream at the bottleneck link depends on the range of variation of its congestion window size. If not constrained, the size of the congestion window for one stream may grow beyond the level that is strictly needed for achievement of the desired video quality level. At the same time, a congestion window size larger than strictly necessary for video quality satisfaction may compromise the video quality satisfaction of one or more of the other video streams that share the same bottleneck link.

In at least some embodiments, methods are provided for controlling the size of the congestion window of a TCP sender in a manner for satisfying the maximum size requirement discussed above. The methods for controlling the size of the congestion window of a TCP sender are configured to stop the growth of the congestion window size beyond the level that is strictly necessary to reach and maintain the data rate that supports the desired quality level. A second embodiment of the present disclosure, called TCP window cap (TWC), provides a method of operating a TCP sender which satisfies the maximum size requirement discussed above. The TWC method may impose a maximum size of the congestion window that may be smaller than the receiver window size advertised by the TCP receiver. The target data rate of the TCP connection may drive the choice of the maximum size of the congestion window imposed by the TWC method. It will be appreciated that application of the TWC method is not restricted to TCP senders associated with adaptive bit-rate video sources, but may be extended to any TCP sender that is associated with a target data rate.

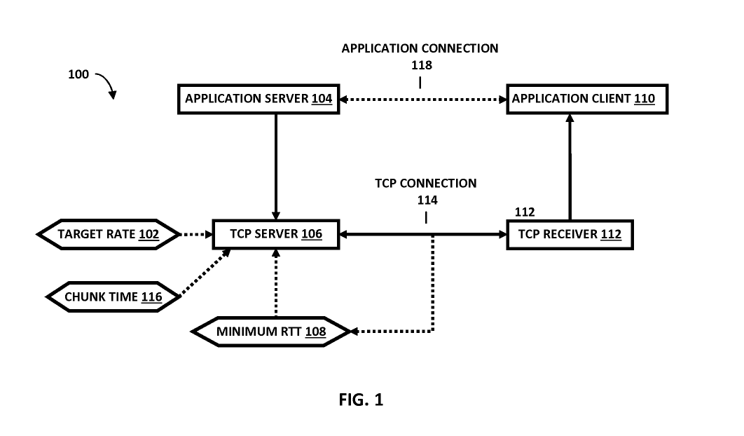

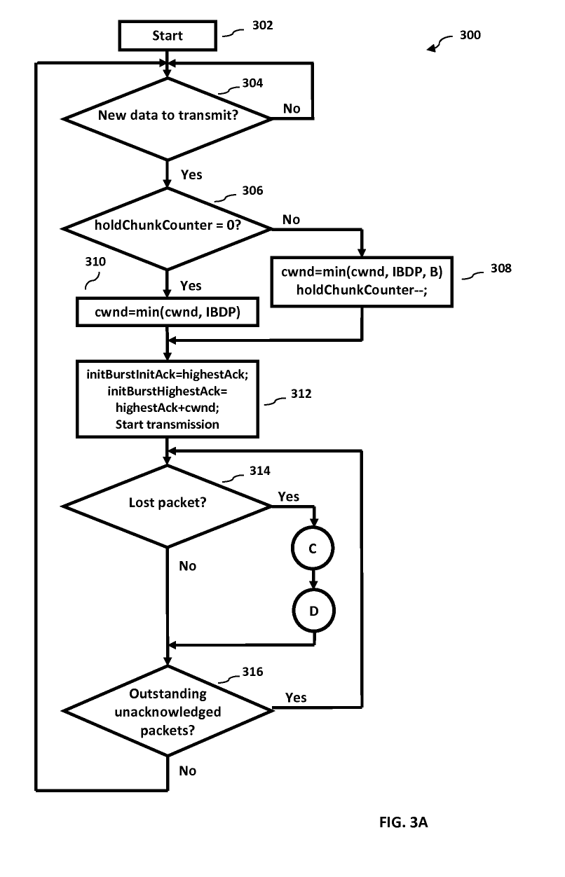

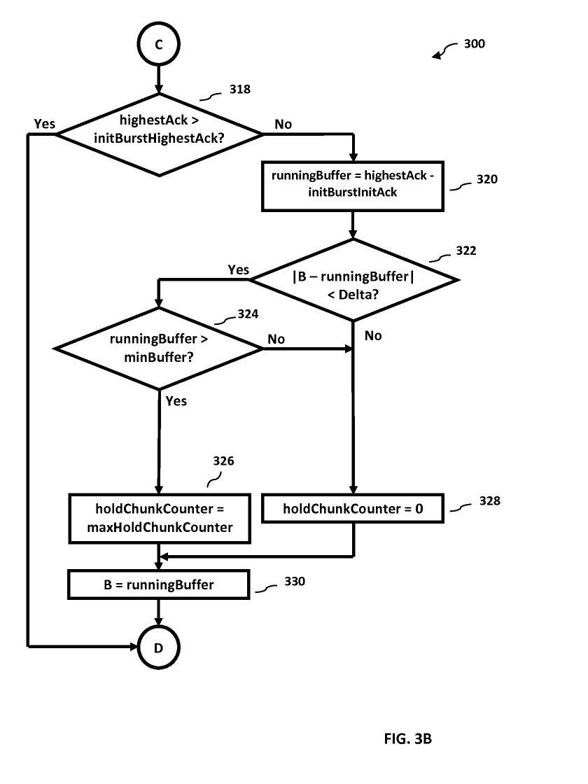

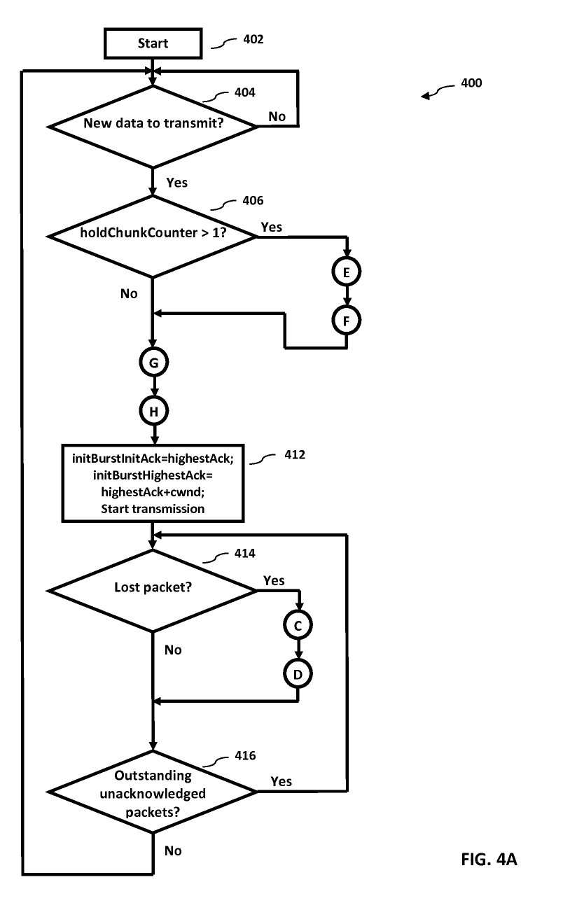

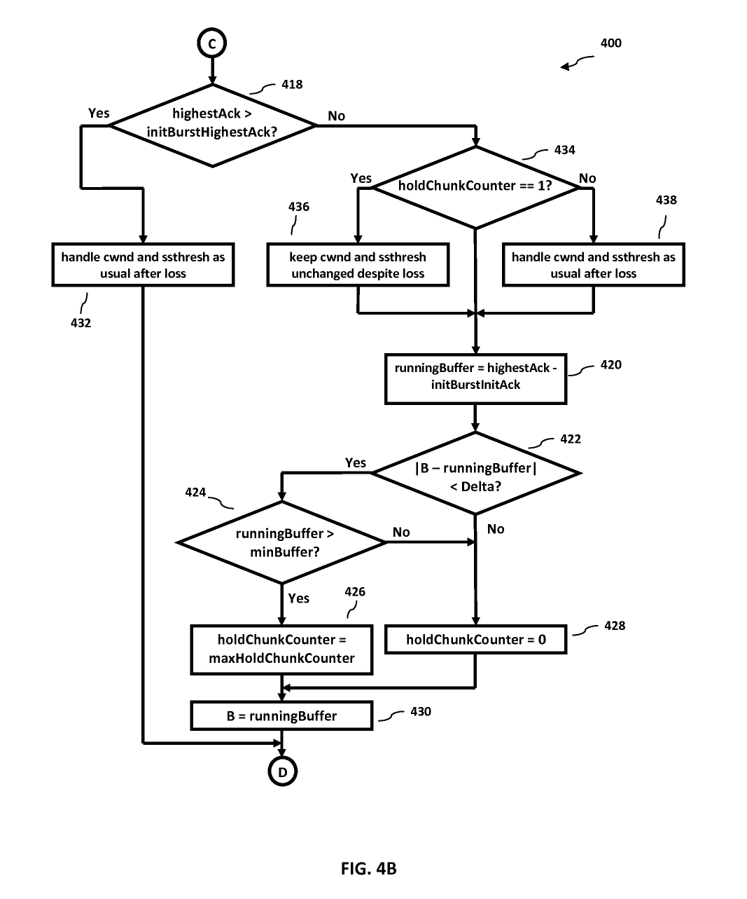

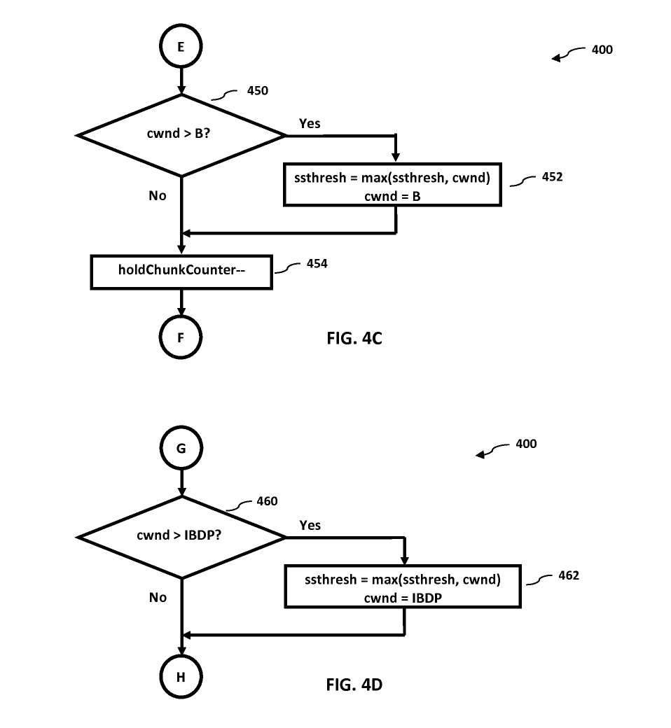

Referring to FIG. 1, a system in which the methods of the present disclosure can be performed is shown. The system 100 includes an application server 104, a TCP sender 106, a TCP receiver 112, and an application client 110. The application server 104 and application client 110 are connected via an application connection 118. The TCP server 106 and TCP receiver 112 are connected via a TCP connection 114 (which also may be referred to more generally as a network connection or an information transmission connection). In at least some embodiments, TCP sender 106 is configured to perform various functions of the present disclosure. TCP sender 106 is part of a communication system in which data are conveyed (i.e., transmitted and/or received) in compliance with the TCP protocol. For example, video data in the form of packets (i.e., a stream of packets) are transferred from application server 104 to TCP sender 106 after application client 110 requests the video data from application server 104 over application connection 118 (e.g., using an HTTP GET method). TCP sender 106 sends the received video data over TCP connection 114 to TCP receiver 112, which is connected to application client 110. TCP sender 106 receives or obtains certain parameters which may be used to provide various embodiments of the present disclosure. In at least some embodiments, such as a first embodiment of the TWR method of a first embodiment of the present disclosure (e.g., depicted and described with respect to FIGS. 3A and 3B), the parameters may include a target rate (denoted as target rate 102), a minimum round-trip time (denoted as minimum RTT 108, and which also may be referred to herein using “minRTT”), and a chunk time r (denoted as chunk time 116). In at least some embodiments, such as a second embodiment of the TWR method of a first embodiment of the present disclosure (e.g., depicted and described with respect to FIGS. 4A, 4B, 4C, and 4D), the parameters may include a target rate (denoted as target rate 102) and a minimum round-trip time (denoted as minimum RTT 108, and which also may be referred to herein using “minRTT”). These parameters may be received by TCP sender 106 from any suitable source(s) of such information, which may include one or more of the devices shown in FIG. 1. For example, the TCP source 106 may obtain the target rate 102 from the application server 104 or from the application client 110. In one embodiment (e.g., a first embodiment of the TWR method of the first embodiment of the present disclosure, such as the embodiment depicted and described in FIGS. 3A and 3B), the target rate 102 is the encoding rate of the highest video quality level of the streamed video. In one embodiment (e.g., a second embodiment of the TWR method of the first embodiment of the present disclosure, such as the embodiment depicted and described in FIGS. 4A, 4B, 4C, and 4D), the target rate 102 is the encoding rate R_{high} of the highest video quality level of the streamed video, multiplied by a fixed correction factor a (e.g., α=1.1) that compensates for certain overheads (e.g., TCP and HTTP overheads). It is noted that, the higher the encoding rate, the higher the number of bits that are used to encode a frame of the video; thus each segment of video, also referred to as a video chunk, contains relatively more bits as the encoding rate is increased. The RTT represents the time elapsed from the time TCP sender 106 transmits a data packet to the time a corresponding ACK packet transmitted by TCP receiver 112 is received by TCP sender 106. For example, the TCP source 106 may obtain the minimum RTT from the sequence of RTT samples that TCP sender 106 collects as it keeps receiving acknowledgment packets transmitted by TCP receiver 112. For example, the TCP source 106 may obtain chunk time 116 from the application server 104 or from the TCP receiver 112.

The TWR and TWC methods of the present disclosure control the size of the congestion window of TCP sender 106 using congestion window size values determined based on an ideal bandwidth-delay product (IBDP).

In at least some embodiments, such as a first embodiment of the TWR method of the first embodiment of the present disclosure (e.g., depicted and described with respect to FIGS. 3A, and 3B), the ideal bandwidth-delay product IBDP may depend on, and may be determined based on, the target rate 102, the minimum RTT 108, and the chunk time 116. In one embodiment of the disclosure where the target rate 102 is derived from the encoding rates of the content to be delivered (e.g., streamed video), the IBDP may be defined by the formula IBDP=R_{high}·minRTT·τ/(τ−minRTT) , where R_{high} represents the highest encoding rate available at the video application server for the video stream being transmitted and r is the fixed time duration of each chunk (i.e., the chunk time) of the video stream (e.g., 2 seconds, 4 seconds, or 10 seconds).

In at least some embodiments, such as a second embodiment of the TWR method of a first embodiment of the present disclosure (e.g., depicted and described with respect to FIGS. 4A, 4B, 4C, and 4D), the ideal bandwidth-delay product IBDP may depend on, and may be determined based on, the target rate 102 and the minimum RTT 108. In one embodiment of the disclosure where the target rate 102 is derived from the encoding rates of the content to be delivered (e.g., streamed video), the IBDP may be defined by the formula IBDP=α·R_{high}·minRTT.

When the propagation delays of the forward and reverse data paths of TCP connection 114 between TCP sender 106 and TCP receiver 112 are fixed, the most accurate approximation of the minimum RTT is given by the minimum of all the RTT samples collected up to the time when the minimum RTT is used. In this case the value of the ideal bandwidth-delay product can be updated every time the value of the minimum RTT drops. Instead, if the data path between the TCP sender 106 and the TCP receiver 112 is subject to changes, for example because the TCP receiver 112 resides in a mobile device, the minimum RTT may at times need to be increased. To allow for possible increases in minimum RTT, TCP sender 106 maintains two values of minimum RTT, called the working minimum RTT (wminRTT) and the running minimum RTT (rminRTT), where wminRTT is the value of minimum RTT 108 that is used to calculate various parameters as will be discussed infra, while rminRTT is the value of minimum RTT that is being updated but is not yet used. At time intervals of duration T (e.g., T=60 sec), called the IBDP update period, TCP sender 106 sets the working minimum RTT equal to the running minimum RTT (i.e., wminRTT=rminRTT), uses the working minimum RTT to update the IBDP, and resets the running minimum RTT to an arbitrarily large value (e.g., rminRTT=10 sec). During the IBDP update period, TCP sender 106 keeps updating rminRTT every time it collects a new RTT sample x, where rminRTT is updated as rminRTT=min(rminRTT, x). The calculation of the IBDP may require that the encoding rate R_{high} of the highest video quality level expected for the stream be passed to TCP sender 106 as soon as possible after TCP connection 114 is established.

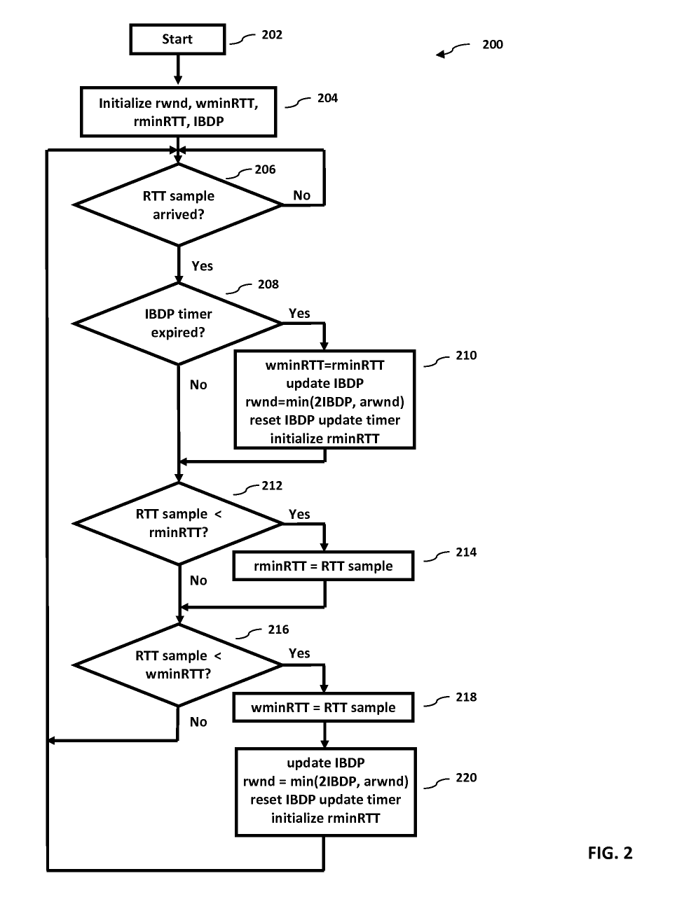

Referring now to FIG. 2, method 200 for calculating the minimum RTT (minRTT) is performed. It will be understood that the steps of method 200 of FIG. 2 may be performed by TCP sender 106, which may be implemented using one or more of electronic circuits, electrical circuits, optical circuits, or the like, as well as various combinations thereof. TCP sender 106 may further comprise one or more microprocessors and/or digital signal processor and associated circuitry controlled or operated in accordance with software code consistent with the methods of the present disclosure. It should be well understood that the method of calculating minRTT is not limited to be performed by TCP sender 106 as described herein or any other similar device or system. The steps of method 200 may be performed by any device, system, or apparatus, part of whose operation can be dictated by instructions, software, or programs that are consistent with method 200.

In step 202, TCP sender 106 is ready to perform the calculation of minRTT and, thus, method 200 starts. In step 204, several variables and parameters, which are all discussed above, are initialized: the variable rwnd, which is the receiver window value maintained by TCP sender 106 based on the advertised receiver window arwnd chosen by TCP receiver 112; the variable wminRTT, which is the working minimum RTT; the variable rminRTT, which is the running minimum RTT; the variable IBDP, which is the ideal bandwidth-delay product; and the parameter T, which is the IBDP update period. After having initialized the above variables and parameter, method 200 proceeds to step 206, at which point TCP sender 106 waits for an RTT sample to arrive.

In step 208, upon the arrival of a new RTT sample (e.g., computed after receipt of an acknowledgment packet), a determination is made as to whether the IBDP timer has expired. Expiration of the IBDP timer signals when the IBDP and other variables controlled method 200 are to be updated as discussed with respect to step 210 below. If the IBDP timer has not expired, method 200 proceeds to step 212, at which point a determination is made as to whether the RTT sample that was just received is less than the latest calculated value of rminRTT. If the RTT sample just received is less than the latest calculated value of rminRTT then method 200 proceeds to step 214, at which point rminRTT is set to the value of the just received RTT sample. Still in step 212, if the just received RTT sample is not less than the value of rminRTT then the same value of rminRTT is maintained and method 200 proceeds to step 216, at which point a determination is made as to whether the RTT sample that was just received is less than the latest calculated value of wminRTT. If the RTT sample just received is less than the latest calculated value of wminRTT then method 200 proceeds to step 218 (at which point wminRTT is set to the value of the just received RTT sample) and then to step 220 (at which point the following tasks are performed: update the IBDP value using the new value of wminRTT and the target rate from source 102; update the receiver window rwnd as the minimum between the advertised receiver window and twice the ideal bandwidth delay product (i.e., rwnd=min(arwnd,2IBDP)); reset the IBDP update timer; reset rminRTT to a relatively large value (e.g., rminRTT=10 s or any other suitable value)). Still in step 216, if the just received RTT sample is not less than the value of wminRTT, then the same value of wminRTT is maintained and method 200 returns to step 206 to wait for the next RTT sample.

Returning to step 208, if the IBDP timer has indeed expired, then method 200 proceeds to step 210 (at which point the following tasks are performed: set wminRTT to the value of rminRTT, update the IBDP using the new value of wminRTT and the target rate from source 102, update the receiver window rwnd as the minimum between the advertised receiver window and twice the ideal bandwidth delay product (i.e., rwnd=min(arwnd ,2IBDP)), reset the IBDP update timer, and reset rminRTT to a relatively large value (e.g., rminRTT=10 s or any other suitable value)), and then proceeds to step 212 to determine whether the just received RTT sample is less than the current value of rminRTT. If the RTT sample is less than rminRTT, method 200 proceeds to step 214, at which point rminRTT is reset to the value of the just received RTT sample. If the RTT sample is not less than rminRTT, the value of rminRTT is kept unchanged and method 200 returns to step 206 to wait for the next RTT sample.

It will be appreciated that, although omitted from FIG. 2 for purposes of clarity, in at least some embodiments method 200 of FIG. 2 may be adapted such that method 200 returns to step 206 from step 212 (based on a determination that the RTT sample is not less than rminRTT) and from step 214 (where step 214 is performed based on a determination at step 212 that the RTT sample is less than rminRTT), and steps 216, 218, and 220 are not included as part of method 200. It will be appreciated that other modifications of method 200 of FIG. 2 are contemplated.

Referring now to FIGS. 3A and 3B, method 300, which is a first embodiment of the TWR method of the first embodiment of the present disclosure, is performed. It will be understood that the steps of method 300 may be performed by TCP sender 106, which may be implemented using one or more of electronic circuits, electrical circuits, optical circuits, or the like, as well as various combinations thereof. TCP sender 106 may control the size of the TCP congestion window such that the probability of packet losses occurring during the initial burst of a video chunk transmission is minimal. As previously discussed, when no packet losses occur during the initial burst of a video chunk transmission, the size of the congestion window (e.g., the average size of the congestion window) during the entire chunk transmission is relatively higher, and therefore conducive to a relatively higher throughput sample for the chunk. As discussed above, TCP sender 106 may further comprise one or more microprocessors and/or digital signal processor and associated circuitry controlled or operated in accordance with software code consistent with the methods of the present disclosure. It should be well understood that the embodiment of the TWR method of the first embodiment of the present disclosure, as depicted in FIGS. 3A and 3B, is not limited to be performed by TCP sender 106 as described herein or any other similar device or system. The steps of method 300 may be performed by any device, system, or apparatus, part of whose operation can be dictated by instructions, software, or programs that are consistent with method 300.

In step 302, TCP sender 106 is ready to perform the first embodiment of the TWR method of the first embodiment of the present disclosure and, thus, method 300 starts. At step 304, TCP sender 106 waits for new data to transmit to become available from application server 104. The new data may include any type of application data requested by application client 110 from application server 104. For adaptive bit-rate video streaming, for example, the new data includes a new video chunk. After the new data to transmit becomes available for transmission at step 304, method 300 proceeds to step 306, at which point a determination is made as to whether the value of the counter variable holdChunkCounter satisfies a threshold (illustratively, whether the value of the counter variable holdChunkCounter is equal to zero, although it will be appreciated that any other suitable threshold may be used). The counter variable holdChunkCounter provides the number of future consecutive chunks during which the same estimate B of the bottleneck buffer size will be considered valid. When the counter reaches zero (0), the estimate B of the bottleneck buffer size is no longer considered valid and a new valid value must be obtained by TCP sender 106 before it can use again the buffer size estimate in the first embodiment of the TWR method of the first embodiment of the present disclosure. If the value stored in holdChunkCounter is zero (0), method 300 proceeds to step 310. If the value stored in holdChunkCounter is not zero (0), method 300 proceeds to step 308. At step 308, before transmission of the new data chunk begins, the size of the congestion window (cwnd) is reset to the minimum of its current value (cwnd), the ideal bandwidth-delay product (IBDP), and the estimated size of the bottleneck buffer (B) (namely, cwnd=min(cwnd, IBDP, B)), the value of the down counter holdChunkCounter is decremented by one unit, and method 300 then proceeds to step 312. At step 310, the size of the congestion window is reset to the minimum of its current value and of the ideal bandwidth-delay product (cwnd=min(cwnd, IBDP)), and then proceeds to step 312. At step 312, the highest acknowledgment number received so far (found in the variable highestAck) is copied into the initBurstInitAck variable, the acknowledgement number that TCP sender 106 expects for the last packet in the initial burst is stored into the initBurstHighestAck variable (initBurstHighestAck=highestAck+cwnd), TCP sender 106 begins transmitting packets that carry the new data chunk (e.g., following the ordinary mode of operation of TCP sender 106 described above), and method 300 then proceeds to step 314.

At step 314, a determination is made as to whether there is a packet loss during transmission of the data chunk (e.g., by expiration of the retransmission timeout, by receipt of duplicate acknowledgments, or the like). If a packet loss is not detected at step 314 (during transmission of the data chunk), TCP sender 106 concludes that the estimated size of the bottleneck buffer B is not oversized, and method 300 proceeds to step 316 directly from step 314. If a packet loss is detected at step 314 (during transmission of the data chunk), method 300 proceeds to step 318 (depicted in FIG. 3B). At step 318, highestAck, which is the highest acknowledgment number received so far, is compared with the value of initBurstHighestAck. If, at step 318, a determination is made that highestAck is larger than initBurstHighestAck (which indicates that all of the packets of the initial burst have reached the TCP receiver 114 correctly and, thus, that the current estimate B of the bottleneck buffer size is not oversized), method 300 proceeds to step 316. If, at step 318, a determination is made that highestAck is not larger than initBurstHighestAck (from which TCP sender 106 infers that the packet loss occurred during the initial burst, and that the value used for resetting the congestion window at the beginning of the chunk transmission was larger than the bottleneck buffer), method 300 proceeds to step 320 (at which point TCP sender 106 obtains a new sample of the bottleneck buffer size as runningBuffer=highestAck−initBurstInitAck) and then proceeds to step 322 (at which point the difference between runningBuffer and the previous buffer size estimate B is computed and the absolute value of the difference is then compared with a relatively small threshold delta (e.g., delta may represent the data payload carried by two packets)). If, at step 322, the absolute value of the difference between runningBuffer and the previous buffer size estimate B is not smaller than the small threshold delta (which indicates that the buffer space available in front of the bottleneck link is not stable and cannot be trusted for resetting the size of the congestion window prior to future chunk transmissions), method 300 proceeds to step 328 (at which point holdChunkCounter is reset to zero as a way to avoid using the buffer size estimate B when the size of the congestion window is reset again at step 310), then proceeds to step 330. If, at step 322, the absolute value of the difference between runningBuffer and the previous buffer size estimate B is smaller than the small threshold delta, method 300 proceeds to step 324. At step 324, a determination is made as to whether the value of runningBuffer is larger than an activation threshold minBuffer (e.g., minBuffer may represent the data payload carried by 10 packets, 20 packets, or any other suitable number of packets). If, at step 324, the value of runningBuffer is larger than minBuffer (in which case the last collected sample of the bottleneck buffer size is considered to be valid), method 300 proceeds to step 326. If, at step 324, the value of runningBuffer is not larger than minBuffer (in which case the last collected sample of the bottleneck buffer size is not considered to be valid), method 300 proceeds to step 328 (at which point, as indicated above, the holdChunkCounter is reset to zero as a way to avoid using the buffer size estimate B when the size of the congestion window is reset again at step 310). At step 326, after having established that the current estimate B of the bottleneck buffer size is stable and can be trusted for resetting the size of the congestion window at step 308, the holdChunkCounter is set to an initialization value stored in maxHoldChunkCounter (e.g., maxHoldChunkCounter=30 data chunks or any other suitable number of data chunks), and method 300 then proceeds to step 330. At step 330, the estimate B of the bottleneck buffer size is set equal to the last buffer size sample stored in runningBuffer, and method 300 then proceeds to step 316. At step 316, a determination is made as to whether there are outstanding packets for which TCP sender 106 has not yet received an acknowledgment. If, at step 316, a determination is made that there are no outstanding packets for which TCP sender 106 has not yet received an acknowledgment, method 300 returns to step 304, at which point TCP sender 106 waits for new data to transmit. If, at step 316, a determination is made that there are one or more outstanding packets for which TCP sender 106 has not yet received an acknowledgment, method 300 returns to step 314, at which point TCP sender 106 waits for a packet loss event. The ensuing text provides further explanation for the steps of the first embodiment of the TWR method of the first embodiment of the present disclosure (as depicted in FIGS. 3A and 3B). When the estimate B of the bottleneck buffer size is not oversized with respect to the space actually available at the bottleneck buffer, the first embodiment of the TWR method of the first embodiment of the present disclosure described in method 300 ensures that no packet losses occur during the initial burst. If the bottleneck buffer space increases for any reason (e.g., a change in traffic conditions, or possibly even a prior downsizing error in the estimation of the available space), maximization of the data rate of TCP connection 114 compels TCP sender 106 to take advantage of it. In order to detect such an increase, TCP sender 106 periodically probes for a larger buffer size by suspending the use of B in the TWR equation that sets cwnd at the beginning of the chunk transmission. When TCP sender 106 collects a sample of runningBuffer that is within minimum distance of the previous sample, it sets B to the minimum of the two and starts the down counter holdChunkCounter from a provisioned value maxHoldChunkCounter. Before transmitting a new chunk, TCP sender 106 determines whether the holdChunkCounter is null. If a determination is made that the holdChunkCounter is null, TCP sender 106 avoids using B in the equation that resets cwnd. If a determination is made that the holdChunkCounter is not null, it decrements holdChunkCounter and includes the current value of B in the TWR equation. When holdChunkCounter is null, TCP sender 106 can set holdChunkCounter to maxHoldChunkCounter only after collecting again two consecutive samples of runningBuffer that are tightly close to each other. Conversely, TCP sender 106 may detect a packet loss during the initial burst when holdChunkCounter is not null, in which case TCP sender 106 may immediately reset holdChunkCounter to zero and suspend the use of B in the TWR equation. The value of maxHoldChunkCounter determines the extension of the time interval during which TCP sender 106 maintains the same value of B in the TWR equation for resetting the congestion window size, before trying to increase it again. For example, with τ=2 s, setting maxHoldChunkCounter to 30 gives a total hold time of 60 s for the current value of B (provided that during the same time TCP sender 106 never detects a packet loss during the initial burst).

The method 300 of FIGS. 3A and 3B corresponds to the first embodiment of the TWR method of the first embodiment of the present disclosure that is intended for general video delivery service deployments where explicit coordination is not possible between the configuration of the bottleneck buffer and the configuration of the TCP sender 106. In such deployments, the TCP sender 106 executes steps for deriving an estimate of the bottleneck buffer size from the detection of packet loss events, and for disabling the use of the estimate when the estimate is likely to be inaccurate. Other embodiments of the present disclosure can be devised that are intended for service deployments in which the same service provider controls the configuration of both the bottleneck link and the TCP sender 106. In such embodiments, the service provider can provision the value of the bottleneck buffer size B used for resetting the size of the congestion window at the beginning of a new chunk transmission.

Referring now to the TCP window cap method of the second embodiment of the present disclosure, TCP sender 106 imposes an upper bound on the size of the congestion window. The upper bound may be twice the value of the ideal bandwidth-delay product IBDP as defined for the first embodiment of the TWR method of the first embodiment of the present disclosure: 2IBDP=2 minRTT·R_{high}·τ/(τ−minRTT). TCP sender 106 obtains the value of minRTT according to method 200 of FIG. 2 as discussed above. As shown in FIG. 1, TCP sender 106 obtains the value of the target rate R_{high} 102 from a suitable source of such information and obtains the value of the chunk time τ 116 from a suitable source of such information. By preventing the congestion window from growing beyond twice the size that is strictly needed for support of the highest video quality level, the TCP source refrains from subtracting critical shares of the bottleneck link data rate from other adaptive bit-rate video streams that may be sharing the same bottleneck link. The result is a substantial mitigation of unfairness effects when multiple video streams share the same bottleneck link and buffer: by capping the data rate consumed by streams bound to small-screen devices, the method leaves higher data rates available to the more demanding streams that are bound to devices with larger screens.

With a shared tail-drop buffer at the bottleneck link, the TWC method most effectively conduces to the elimination of unfairness and video quality instability when:

(a) the bottleneck rate C is at least as large as the sum of the encoding rates R_{high,i}, of the highest video quality levels for all the streams i that share the bottleneck link, each amplified by the amount needed by the respective client to measure the same rate, i.e.,

Σᵢ[R_{high,i}·τᵢ/(τᵢ−minRTTᵢ)]≦C, and

(b) the size B of the shared buffer is at least as large as the sum of the ideal bandwidth delay products IBDPᵢ computed for each stream i that shares the bottleneck link, i.e., Σᵢ[R_{high,i}·minRTTᵢ·τᵢ/(τᵢ−minRTTᵢ)]≦B.

Indeed, if the above conditions on bottleneck data rate and bottleneck buffer size are both satisfied, and the TWC method is applied to the TCP sender in conjunction with the TWR method, the bottleneck buffer is guaranteed to never overflow and cause packet losses, because each stream i never places in the buffer more than IBDPᵢ data units.

A TCP sender 106 that implements the TWC method of the second embodiment of the present invention computes the ideal bandwidth-delay product IBDP the same way as described in method 200 of FIG. 2. For enforcement of the upper bound 2IBDP that the TWC method imposes on the size of the congestion window, TCP sender 106 can modify the way it maintains the receiver window variable rwnd that records the receiver window arwnd advertised by the TCP receiver 112. Every time the IBDP value changes or TCP sender 106 receives a new value of arwnd from TCP receiver 112, TCP sender 106 updates rwnd as follows: rwnd=min(arwnd,2IBDP) . The new upper bound on the congestion window size cwnd becomes immediately effective, because by ordinary operation of TCP sender 106 rwnd is used in every upward update of the congestion window size: cwnd=min(cwnd,rwnd).

Referring now to FIGS. 4A, 4B, 4C, and 4D, method 400, which is a second embodiment of the TWR method of the first embodiment of the present disclosure, is performed. It will be understood that the steps of method 400 may be performed by TCP sender 106, which may be implemented as comprising electronic, electrical, optical or a combination thereof circuits. TCP sender 106 may control the size of the TCP congestion window such that the probability of packet losses occurring during the initial burst of a video chunk transmission is minimal. As previously discussed, when no packet losses occur during the initial burst of a video chunk transmission, the size of the congestion window during the entire chunk transmission is relatively higher, and therefore conducive to a relatively higher throughput sample for the chunk. As discussed above, TCP sender 106 may further comprise one or more microprocessors and/or digital signal processor and associated circuitry controlled or operated in accordance with software code consistent with the methods of the present disclosure. It should be well understood that the second embodiment of the TWR method of the first embodiment of the present disclosure, as depicted in FIGS. 4A, 4B, 4C, and 4D, is not limited to be performed by TCP sender 106 as described herein or any other similar device or system. The steps of method 400 may be performed by any device, system, or apparatus, part of whose operation can be dictated by instructions, software, or programs that are consistent with method 400.

In step 402, TCP sender 106 is ready to perform the second embodiment of the TWR method of the first embodiment of the present disclosure and, thus, method 400 starts. At step 404, TCP sender 106 waits for new data to transmit to become available from application server 104. The new data may include any type of application data requested by application client 110 from application server 104. For adaptive bit-rate video streaming, for example, the new data to transmit includes a new video chunk. After the new data to transmit becomes available for transmission at step 404, method 400 proceeds to step 406, at which point a determination is made as to whether the value of the counter variable holdChunkCounter satisfies a threshold (illustratively, whether the value of the counter variable holdChunkCounter is greater than one, although it will be appreciated that any other suitable threshold may be used). The counter variable holdChunkCounter provides the number of future consecutive chunks during which the same estimate B of the bottleneck buffer size will be considered valid. When the counter reaches zero (0), the estimate B of the bottleneck buffer size is no longer considered valid and a new valid value must be obtained by TCP sender 106 before it can use again the buffer size estimate in the second embodiment of the TWR method of the first embodiment of the present disclosure. When the counter reaches one (1), the second embodiment of the TWR method of the first embodiment of the present disclosure suspends the use of the estimate B of the bottleneck buffer size in its control of the congestion window size before the start of a video chunk transmission. If a determination is made at step 406 that the value stored in holdChunkCounter is not greater than one, method 400 proceeds to step 460 (depicted in FIG. 4D). If a determination is made at step 406 that the value stored in holdChunkCounter is greater than one, method 400 proceeds to step 450 (depicted in FIG. 4C). At step 450, before starting the transmission of the new data, a determination is made as to whether the current congestion window size cwnd is larger than the estimated bottleneck buffer size B. If a determination is made at step 450 that the congestion window size cwnd is larger than the estimated bottleneck buffer size B, method 400 proceeds to step 452, at which point the slow-start threshold (ssthresh) is set equal to the maximum of its current value and the current congestion window size (ssthresh=max(ssthresh, cwnd)) and the congestion window size cwnd is reset equal to the estimated bottleneck buffer size B (cwnd=min(cwnd, B)). From step 452, method 400 proceeds to step 454, at which point the value of the down counter holdChunkCounter is decremented by one unit, and method 400 then proceeds to step 460. If a determination is made at step 450 that the current congestion window size cwnd is not larger than the estimated size of the bottleneck buffer B, method 400 proceeds directly to step 454, at which point the down counter holdChunkCounter is decremented, and method 400 then proceeds to step 460. At step 460, a determination is made as to whether the current congestion window size cwnd is larger than the ideal bandwidth-delay product IBDP. If the current congestion window size cwnd is not larger than IBDP, method 400 proceeds to step 412. If the current congestion window size cwnd is larger than IBDP, method 400 proceeds to step 462, at which point the slow-start threshold is set equal to the maximum of its current value and of the current congestion window size (ssthresh=max(ssthresh, cwnd)) and the size of the congestion window is reset to the ideal bandwidth-delay product (cwnd=IBDP), and method 400 then proceeds to step 412. At step 412, the highest acknowledgment number received so far (found in the variable highestAck) is copied into the initBurstlnitAck variable, the acknowledgement number expected by TCP sender 106 for the last packet in the initial burst is stored into variable initBurstHighestAck (initBurstHighestAck=highestAck+cwnd), TCP sender 106 begins transmitting packets that carry the new data (e.g., following the ordinary mode of operation of TCP sender 106 described above), and method 400 then proceeds to step 414.

At step 414, a determination is made as to whether there is a packet loss during transmission of the data chunk (e.g., by expiration of the retransmission timeout, by receipt of duplicate acknowledgments, or the like). If a packet loss is not detected during transmission of the data chunk), TCP sender 106 concludes that the estimated size of the bottleneck buffer B is not oversized and method 400 proceeds to step 416 directly from step 414. If a packet loss is detected during transmission of the data chunk, method 400 proceeds to step 418 (depicted in FIG. 4B). At step 418, highestAck, which is the highest acknowledgment number received so far, is compared with the value of initBurstHighestAck. If, at step 418, a determination is made that highestAck is larger than initBurstHighestAck (which indicates that all of the packets of the initial burst have reached the TCP receiver 112 correctly and, thus, that the current estimate B of the bottleneck buffer size is not oversized), method 400 proceeds to step 432, at which point the slow-start threshold ssthresh is updated and the congestion window size cwnd is updated as after any packet loss of the same type, according to the specific TCP congestion control scheme in use, and method 400 then proceeds to step 416. If, at step 418, a determination is made that the value in highestAck is not larger than initBurstHighestAck when the packet loss is detected (from which TCP sender 106 infers that the packet loss occurred during the initial burst and, thus, that the value used for resetting the congestion window at the beginning of the chunk transmission was larger than the bottleneck buffer), method 400 proceeds to step 434, at which point a determination is made as to whether the value in holdChunkCounter satisfies a threshold (illustratively, whether the value of the counter variable holdChunkCounter is equal to one, although it will be appreciated that any other suitable threshold may be used). If a determination is made at step 434 that the value of holdChunkCounter is equal to one (which indicates that the estimated size of the bottleneck buffer B was not used to reset the congestion window size B before starting the transmission of the chunk, so the packet loss was most likely caused by the temporary suspension of the use of B for resetting cwnd, such suspension being intended to probe the bottleneck buffer for a possibly increased size), method 400 proceeds to step 436, at which point, in order to avoid punishing TCP sender 106 for this periodic probing exercise (the period being determined by the parameter maxHoldChunkCounter), the values of ssthresh and cwnd are not lowered as they normally would after a packet loss but, rather, are kept unchanged despite the loss. If a determination is made at step 434 that the value of holdChunkCounter is not equal to one, method 400 proceeds to step 438, at which point the values of ssthresh and cwnd are handled as they normally would be after a loss (e.g., using ordinary corrections of the values of ssthresh and cwnd). The method 400 reaches step 420 from both step 436 and step 438.

At step 420, a new sample of the bottleneck buffer size is obtained (as runningBuffer=highestAck−initBurstInitAck), and method 400 then proceeds to step 422. At step 422, the difference between runningBuffer and the previous buffer size estimate B is computed and the absolute value of the difference is compared with a relatively small threshold delta (e.g., delta may represent the data payload carried by two packets, the data payload carried by four packets, or the like). If the absolute value of the difference computed at step 422 is not smaller than delta (which is indicative that the buffer space available in front of the bottleneck link is not stable and cannot be trusted for resetting the size of the congestion window prior to future chunk transmissions), method 400 proceeds to step 428. If the absolute value of the difference computed at step 422 is smaller than delta, method 400 proceeds to step 424. At step 424, TCP sender 106 determines whether the value of runningBuffer is larger than an activation threshold minBuffer (e.g., minBuffer may represent the data payload carried by ten packets). If the value in runningBuffer is larger than minBuffer, the last collected sample of the bottleneck buffer size is considered to be valid and method 400 proceeds to step 426. If the value in runningBuffer is not larger than minBuffer, the last collected sample of the bottleneck buffer size is considered to be invalid and method 400 proceeds to step 428. At step 426, after having established that the current estimate B of the bottleneck buffer size is stable and can be trusted for resetting the size of the congestion window at step 408, holdChunkCounter is set to an initialization value stored in maxHoldChunkCounter (e.g., maxHoldChunkCounter=six chunks or any other suitable number of chunks), and method 400 then proceeds to step 430. At step 428, holdChunkCounter is reset to zero as a way to avoid using the buffer size estimate B when the size of the congestion window is reset again before the transmission of the next chunk (illustratively, by ensuring that method 400 proceeds from step 406 to step 460, rather than 450), and method 400 then proceeds to step 430. At step 430, the estimate B of the bottleneck buffer size is set equal to the last buffer size sample stored in runningBuffer, and method 400 then proceeds to step 416 (depicted in FIG. 4A). At step 416, a determination is made as to whether there are outstanding packets for which TCP sender 106 has not yet received an acknowledgment. If a determination is made that there are no outstanding packets for which TCP server 106 has not received an acknowledgement, method 400 returns to step 404 (at which point, as previously discussed, TCP sender 106 waits for new data to transmit). If a determination is made that there are one or more outstanding packets for which TCP server 106 has not received an acknowledgement, method 400 returns to step 414 (at which point, as previously discussed, TCP sender 106 waits for a packet loss event). The ensuing text provides further explanation for the steps of the second embodiment of the TWR method of the first embodiment of the present disclosure shown in FIG. 4B. When the estimate B of the bottleneck buffer size is not oversized with respect to the space actually available at the bottleneck buffer, the second embodiment of the TWR method of the first embodiment of the present disclosure described in method 400 ensures that no packet losses occur during the initial burst. If the bottleneck buffer space increases for any reason (e.g., a change in traffic conditions, or possibly even a prior downsizing error in the estimation of the available space), maximization of the data rate of TCP connection 114 compels TCP sender 106 to take advantage of it. In order to detect such an increase, TCP sender 106 periodically probes for a larger buffer size by suspending the use of B in the TWR equation that sets cwnd at the beginning of the chunk transmission. When TCP sender 106 collects a sample of running Buffer that is within minimum distance of the previous sample, it sets B to the minimum of the two and starts the down counter holdChunkCounter from a provisioned value maxHoldChunkCounter. Before transmitting a new chunk, TCP sender 106 determines whether the holdChunkCounter is null. If a determination is made that the holdChunkCounter is null, TCP sender 106 avoids using B in the equation that resets cwnd. If a determination is made that the holdChunkCounter is not null, TCP sender 106 decrements holdChunkCounter and includes the current value of B in the TWR equation. When holdChunkCounter is null, TCP sender 106 can set holdChunkCounter to maxHoldChunkCounter only after collecting again two consecutive samples of runningBuffer that are tightly close to each other. Conversely, TCP sender 106 may detect a packet loss during the initial burst when holdChunkCounter is not null, in which case TCP sender 106 may immediately reset holdChunkCounter to zero and suspend the use of B in the TWR equation. The value of maxHoldChunkCounter determines the extension of the time interval during which TCP sender 106 maintains the same value of B in the TWR equation for resetting the congestion window size, before trying to increase it again. For example, with τ=2 s , setting maxHoldChunkCounter to 6 gives a total hold time of 12 s for the current value of B (provided that during the same time TCP sender 106 never detects a packet loss during the initial burst).

The method 400 of FIGS. 4A, 4B, 4C, and 4D corresponds to the second embodiment of the TWR method of the first embodiment of the present disclosure that is intended for general video delivery service deployments where explicit coordination is not possible between the configuration of the bottleneck buffer and the configuration of the TCP sender 106. In such deployments, the TCP sender 106 executes steps for deriving an estimate of the bottleneck buffer size from the detection of packet loss events, and for disabling the use of the estimate when the estimate is likely to be inaccurate. Other embodiments of the present disclosure can be devised that are intended for service deployments in which the same service provider controls the configuration of both the bottleneck link and the TCP sender 106. In such embodiments, the service provider can provision the value of the bottleneck buffer size B used for resetting the size of the congestion window at the beginning of a new chunk transmission.

The second embodiment of the TWR method of the first embodiment of the present disclosure uses the estimated bottleneck buffer size B and the target rate α·R_{high} as independent criteria for resetting the slow-start threshold and the congestion window size before starting a new chunk transmission. Either criterion can be suspended by proper setting of certain configuration parameters of the second embodiment of the TWR method of the first embodiment of the present disclosure. For example, the use of the estimated buffer size B may be suspended when the value of the parameter maxHoldChunkCounter is set to zero. Similarly, for example, the use of the target rate may be suspended when the correction factor α, and consequently the target rate α·R_{high}, is assigned an arbitrarily large value (e.g., α=1,000).

Referring now to the TCP window cap method of the second embodiment of the present disclosure, TCP sender 106 imposes an upper bound on the size of the congestion window. The upper bound may be twice the value of the ideal bandwidth-delay product IBDP as defined for the second embodiment of the TWR method of the first embodiment of the present disclosure: 2IBDP=2 minRTT·α·R_{high}. TCP sender 106 obtains the value of minRTT according to method 200 of FIG. 2 as discussed above. As shown in FIG. 1, TCP sender 106 obtains the value of the target rate (α·R_{high}) 102 from a suitable source of such information. By preventing the congestion window from growing beyond twice the size that is strictly needed for support of the highest VQ level, the TCP source refrains from subtracting critical shares of the bottleneck link data rate from other adaptive bit-rate video streams that may be sharing the same bottleneck link. The result is a substantial mitigation of unfairness effects when multiple video streams share the same bottleneck link and buffer: by capping the data rate consumed by streams bound to small-screen devices, the method leaves higher data rates available to the more demanding streams that are bound to devices with larger screens.

With a shared tail-drop buffer at the bottleneck link, the TWC method most effectively conduces to the elimination of unfairness and video quality instability when:

(a) the bottleneck rate C is at least as large as the sum of the target rates α·R_{high,i} of the highest video quality levels for all the streams i that share the bottleneck link, i.e., Σᵢ(α·R_{high,i})≦C, and

(b) the size B of the shared buffer is at least as large as the sum of the ideal bandwidth delay products IBDPᵢ computed for each stream i that shares the bottleneck link, i.e., Σᵢ(α·R_{high,i}·minRTTᵢ)≦B

Indeed, if the above conditions on bottleneck data rate and bottleneck buffer size are both satisfied, and the TWC method is applied to the TCP sender in conjunction with the second embodiment of the TWR method, the bottleneck buffer is guaranteed to never overflow and cause packet losses, because each stream i never places in the buffer more than IBDPᵢ data units.

A TCP sender 106 that implements the TWC method of the second embodiment of the present disclosure computes the ideal bandwidth-delay product IBDP the same way as described in method 200 of FIG. 2. For enforcement of the upper bound 2IBDP that the TWC method imposes on the size of the congestion window, TCP sender 106 can modify the way it maintains the receiver window variable rwnd that records the receiver window arwnd advertised by the TCP receiver 112. Every time the IBDP value changes or TCP sender 106 receives a new value of arwnd from TCP receiver 112, TCP sender 106 updates rwnd as follows:

rwnd=min(αrwnd,2IBDP). The new upper bound on the congestion window size cwnd becomes immediately effective, because by ordinary operation of TCP sender 106 rwnd is used in every upward update of the congestion window size: cwnd=min(cwnd,rwnd).

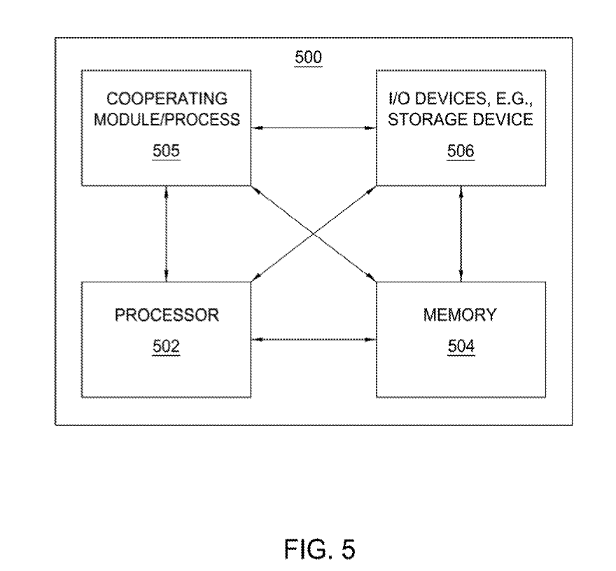

FIG. 5 depicts a high-level block diagram of a computer suitable for use in performing functions described herein.

The computer 500 includes a processor 502 (e.g., a central processing unit (CPU) and/or other suitable processor(s)) and a memory 504 (e.g., random access memory (RAM), read only memory (ROM), and the like).

The computer 500 also may include a cooperating module/process 505. The cooperating process 505 can be loaded into memory 504 and executed by the processor 502 to implement functions as discussed herein and, thus, cooperating process 505 (including associated data structures) can be stored on a computer readable storage medium, e.g., RAM memory, magnetic or optical drive or diskette, solid state memories, and the like.

The computer 500 also may include one or more input/output devices 506 (e.g., a user input device (such as a keyboard, a keypad, a mouse, and the like), a user output device (such as a display, a speaker, and the like), an input port, an output port, a receiver, a transmitter, one or more storage devices (e.g., a tape drive, a floppy drive, a hard disk drive, a compact disk drive, solid state memories, and the like), or the like, as well as various combinations thereof).

It will be appreciated that computer 500 depicted in FIG. 5 provides a general architecture and functionality suitable for implementing functional elements described herein and/or portions of functional elements described herein.

It will be appreciated that the functions depicted and described herein may be implemented in software (e.g., via implementation of software on one or more processors, for executing on a general purpose computer (e.g., via execution by one or more processors) so as to implement a special purpose computer, and the like) and/or may be implemented in hardware (e.g., using a general purpose computer, one or more application specific integrated circuits (ASIC), and/or any other hardware equivalents).

It will be appreciated that at least some of the steps discussed herein as software methods may be implemented within hardware, for example, as circuitry that cooperates with the processor to perform various method steps. Portions of the functions/elements described herein may be implemented as a computer program product wherein computer instructions, when processed by a computer, adapt the operation of the computer such that the methods and/or techniques described herein are invoked or otherwise provided.

Instructions for invoking the inventive methods may be stored in fixed or removable media, transmitted via a data stream in a broadcast or other signal bearing medium, and/or stored within a memory within a computing device operating according to the instructions.

It will be appreciated that the term “or” as used herein refers to a non-exclusive “or,” unless otherwise indicated (e.g., use of “or else” or “or in the alternative”).

It will be appreciated that, although various embodiments which incorporate the teachings presented herein have been shown and described in detail herein, those skilled in the art can readily devise many other varied embodiments that still incorporate these teachings.

What is claimed is:

1. An apparatus, comprising:
a processor and a memory communicatively connected to the processor, the processor configured to:
control a size of a congestion window of an information transmission connection based on a threshold, wherein the threshold is based on an ideal bandwidth-delay product (IBDP) value, wherein the IBDP value is based on a product of an information transmission rate measure and a time measure.

2. The apparatus of claim 1, wherein the information transmission rate measure is based on a target information transmission rate for the information transmission connection.

3. The apparatus of claim 2, wherein the target information transmission rate for the information transmission connection depends on an encoding rate of information to be transmitted via the information transmission connection.

4. The apparatus of claim 2, wherein the target information transmission rate for the information transmission connection depends on an encoding rate of information to be transmitted via the information transmission connection and a correction factor selected to compensate for overhead.

5. The apparatus of claim 1, wherein the time measure is based on a minimum round-trip time measured between a sender of the information transmission connection and a receiver of the information transmission connection.

6. The apparatus of claim 5, wherein the minimum round-trip time is determined from a set of round-trip times measured between the sender of the information transmission connection and the receiver of the information transmission connection.

7. The apparatus of claim 1, wherein the IBDP value is based on a chunk time of a data chunk to be transmitted via the information transmission connection.

8. The apparatus of claim 1, wherein the threshold comprises a cap threshold, wherein the processor is configured to prevent the size of the congestion window from exceeding the cap threshold.

9. The apparatus of claim 8, wherein the processor is configured to:
determine a value of the cap threshold as a minimum of a first value determined as a function of the IBDP value and a second value comprising a receiver window size advertised by a receiver of the information transmission connection.

10. The apparatus of claim 9, wherein the first value is computed to be twice the IBDP value.

11. The apparatus of claim 1, wherein the threshold comprises a reset threshold, wherein the processor is configured to:
reduce the size of the congestion window, prior to transmitting a new information block from a sender of the information transmission connection toward a receiver of the information transmission connection, based on a determination that the size of the congestion window exceeds the reset threshold and based on a determination that the sender of the information transmission connection has received confirmation that one or more information blocks already transmitted by the sender of the information transmission connection toward the receiver of the information transmission connection have been received by the receiver of the information transmission connection.

12. The apparatus of claim 11, wherein the processor is configured to:
reduce the size of the congestion window to be equal to the reset threshold.

13. The apparatus of claim 11, wherein the reset threshold depends on a bottleneck buffer size.

14. The apparatus of claim 13, wherein the bottleneck buffer size is fixed.

15. The apparatus of claim 13, wherein the bottleneck buffer size is determined dynamically after the information transmission connection is established.

16. The apparatus of claim 15, wherein the bottleneck buffer size is determined based on an amount of data transmitted by a sender of the information transmission connection since the sender of the information transmission connection started transmitting a current block of information via the information transmission connection.

17. The apparatus of claim 11, wherein the processor is configured to:
determine a value of the reset threshold as a minimum of the IBDP value and a bottleneck buffer size.

18. The apparatus of claim 1, wherein the processor is configured to control the size of the congestion window based on the threshold and a second threshold, wherein the threshold comprises a cap threshold and the second threshold comprises a reset threshold.

19. The apparatus of claim 18, wherein the processor is configured to:
prevent the size of the congestion window from exceeding the cap threshold; and
reduce the size of the congestion window, prior to transmitting a new information block from a sender of the information transmission connection toward a receiver of the information transmission connection, based on a determination that the size of the congestion window exceeds the reset threshold and based on a determination that the sender of the information transmission connection has received confirmation that one or more information blocks already transmitted by the sender of the information transmission connection toward the receiver of the information transmission connection have been received by the receiver of the information transmission connection.

20. A computer-readable storage medium storing instructions which, when executed by a computer, cause the computer to perform a method, the method comprising:
controlling a size of a congestion window of an information transmission connection based on a threshold, wherein the threshold is based on an ideal bandwidth-delay product (IBDP) value, wherein the IBDP value is based on a product of an information transmission rate measure and a time measure.

21. A method, comprising:
controlling, using a processor and a memory communicatively connected to the processor, a size of a congestion window of an information transmission connection based on a threshold, wherein the threshold is based on an ideal bandwidth-delay product (IBDP) value, wherein the IBDP value is based on a product of an information transmission rate measure and a time measure.

22. An apparatus, comprising:
a processor and a memory communicatively connected to the processor, wherein the processor is configured to control a size of a congestion window of an information transmission connection based on a cap threshold and based on a reset threshold, wherein the processor is configured to
prevent the size of the congestion window from exceeding the cap threshold; and
reduce the size of the congestion window, prior to transmitting a new information block from a sender of the information transmission connection toward a receiver of the information transmission connection, based on a determination that the size of the congestion window exceeds the reset threshold and based on a determination that the sender of the information transmission connection has received confirmation that one or more information blocks already transmitted by the sender of the information transmission connection toward the receiver of the information transmission connection have been received by the receiver of the information transmission connection.
